(19) United States
(12) Patent Application Publication
(10) Pub. No.: US 2024/0025063 A1
(43) Pub. Date: Jan. 25, 2024

(54) RAZOR ASSEMBLY

(71) Applicant: DORCO CO., LTD., Gyeonggi-do (KR)

(72) Inventors: Woo Gyeong GO, Seoul (KR); Dong Il KIM, Seoul (KR)

(73) Assignee: DORCO CO., LTD., Gyeonggi-do (KR)

(21) Appl. No.: 18/043,299

(22) PCT Filed: Aug. 24, 2021
(86) PCT No.: PCT/KR2021/011286

§ 371 Date: Feb. 27, 2023

(30) Foreign Application Priority Data
Aug. 31, 2020 (KR) 10-2020-0109886

(51) Int. Cl. B26B 21/22; B26B 21/40; B26B 21/52

(52) U.S. Cl. CPC B26B 21/225; B26B 21/4012; B26B 21/521

(57) ABSTRACT

A razor assembly is disclosed herein. An embodiment of the present disclosure provides a razor assembly including at least one shaving blade having a cutting edge; a blade housing accommodating the at least one shaving blade to be placed in a longitudinal direction; a connector fixed to one side of the blade housing, the connector including a first connecting portion including a first surface; and a holder rotatably connected to the connector about a rotational axis parallel to the longitudinal direction, the holder including a second connecting portion including a second surface facing the first surface, wherein the connector and the holder are connected to each other by coupling of the first connecting portion and the second connecting portion, and wherein when the connector rotates with respect to the holder about the rotational axis, the first surface is configured to move with respect to the second surface along the second surface.

### TECHNICAL FIELD

The present disclosure relates to a razor assembly.

### BACKGROUND ART

Contents described in the present section simply provide background information for the present disclosure and do not constitute prior art.

A conventional razor assembly, commonly known as a wet razor, includes a razor cartridge and a razor handle.

The razor cartridge is configured to be rotatable about the razor handle between a rest position and a pivoting position that is out of the rest position. A pivoting motion of the razor cartridge is basically centered on a rotational axis parallel to an alignment direction of shaving blades.

The pivoting motion of the razor cartridge centered on the rotational axis allows the shaving blade to smoothly contact a skin of a user, thereby helping to achieve efficient shaving.

Meanwhile, the conventional razor assembly uses a rotary connector to implement the pivoting motion of the razor cartridge. In the rotary connector, the connector is configured to be fixed in position with respect to the razor handle and rotatable about a rotational axis with respect to the razor cartridge.

For example, U.S. Pat. No. 9,193,077 (hereinafter referred to as “Patent Document 1”) discloses a rotational connecting method to such a cartridge. Specifically, a razor assembly of Patent Document 1 includes a cartridge, a connecting member rotatably fixed to the cartridge, and a handle connected to the connecting member, and the connecting member is configured to be fixed in position with respect to the handle.

The rotary connector allows the position of the rotational axis to be adjacent to the position of the foremost shaving blade, thereby providing an effect of providing a more improved pivot function.

However, in the rotary connector, since the razor cartridge and the connector rotatably connected to the razor cartridge form one unit (hereinafter, “cartridge unit”), there is a problem in that a size of the cartridge unit increases.

The cartridge unit may be sold or provided separately from the razor handle in a state of being accommodated in a case such as a dispenser. In this case, when the size of the cartridge unit increases, there is a problem in that the risk of damage to the cartridge unit increases.

Meanwhile, other conventional razor assemblies use a fixed connector to implement the pivoting motion of the razor cartridge. In the fixed connector, the position of the connector is fixed with respect to the razor cartridge and the connector is configured to be rotatable about a rotational axis with respect to the razor handle. For example, Korean Patent No. 10-0903191 (hereinafter referred to as “Patent Document 2”) discloses the fixed connector.

In the case of the fixed connector, since the connector is fixed to the razor cartridge, compared to the rotary connector, the size of the cartridge unit is relatively small.

However, in the case of the fixed connector, since the pivot function is provided inside the razor handle, the structure of the razor handle becomes complicated, and thus, there is a problem in that durability of the razor handle is lowered.

Specifically, in the fixed connector, the razor assembly includes a holder connected to the connector. The holder is placed on the razor handle and connected to the razor handle so as to be rotatable around a rotational axis. The pivot structure of this holder can be a factor in reducing durability of the razor assembly.

### DISCLOSURE

### Technical Problem

Accordingly, a main object of the present disclosure is to provide a razor assembly having a pivot structure capable of reducing a size of a cartridge unit while making a position of the rotational axis adjacent to the foremost shaving blade.

In addition, a main object of the present disclosure is to provide a razor assembly having a pivot structure having high durability.

### Technical Solution

An embodiment of the present disclosure provides a razor assembly including at least one shaving blade having a cutting edge; a blade housing accommodating the at least one shaving blade to be placed in a longitudinal direction; a connector fixed to one side of the blade housing, the connector including a first connecting portion including a first surface; and a holder rotatably connected to the connector about a rotational axis parallel to the longitudinal direction, the holder including a second connecting portion including a second surface facing the first surface, wherein the connector and the holder are connected to each other by coupling of the first connecting portion and the second connecting portion, and wherein when the connector rotates with respect to the holder about the rotational axis, the first surface is configured to move with respect to the second surface along the second surface.

### Advantageous Effects

As described above, according to the present embodiment, the razor assembly can provide an improved pivot function, and can also reduce a size of a cartridge unit.

In addition, the razor assembly can provide a pivot structure having high durability.

### BRIEF DESCRIPTION OF DRAWINGS

FIG. 1 is a perspective view of a razor assembly according to one embodiment of the present disclosure.

FIG. 2 is a rear perspective view of the razor assembly according to one embodiment of the present disclosure.

FIG. 3 illustrates a state in which a razor cartridge of FIG. 2 is separated from a holder.

FIG. 4 is an exploded perspective view of the razor assembly according to one embodiment of the present disclosure.

FIG. 5 is a rear view of the razor assembly according to one embodiment of the present disclosure.

FIG. 6 illustrates a process of assembling the razor cartridge to the holder according to one embodiment of the present disclosure.

FIG. 7 illustrates a state in which the razor cartridge according to one embodiment of the present disclosure is rotating.

FIG. 8 illustrates an operation of a recovering force providing unit when the razor cartridge according to one embodiment of the present disclosure rotates.

FIG. 9 illustrates a process of separating the razor cartridge from the holder according to one embodiment of the present disclosure.

### DETAILED DESCRIPTION

Hereinafter, some exemplary embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

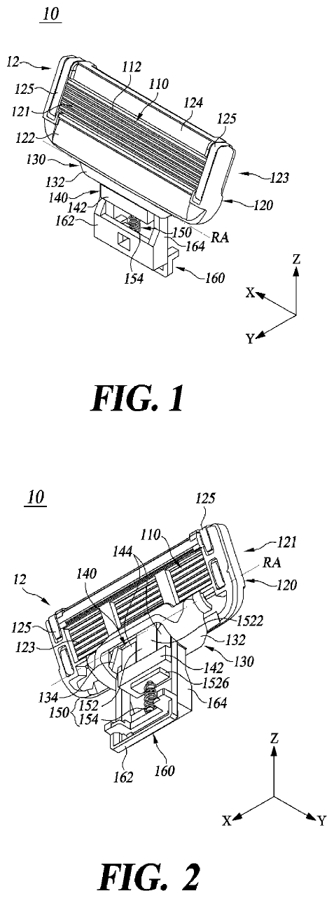

FIG. 1 is a perspective view of a razor assembly 10 according to one embodiment of the present disclosure.

FIG. 2 is a rear perspective view of the razor assembly 10 according to one embodiment of the present disclosure.

Referring to FIGS. 1 and 2, the razor assembly 10 may include a razor cartridge 12, a connector 130, and a holder 140, and the razor cartridge 12 may include at least one shaving blade 110 and a blade housing 120.

At least one shaving blade 110 may have a cutting edge 112 for cutting body hair.

The blade housing 120 may accommodate at least one shaving blade 110 to be placed in a longitudinal direction. Here, the longitudinal direction refers to a width direction of the blade housing 120. For example, in FIG. 1, the longitudinal direction is a direction parallel to an X-axis.

At least one shaving blade 110 may be held by a plurality of clips 125 in a state of being accommodated on one side of the blade housing 120.

The blade housing 120 may include a top surface 121, a bottom surface 123, a guard 122, and a cap 124.

The top surface 121 may be a surface of the blade housing 120 toward which the cutting edge 112 faces, and the bottom surface 123 may be a surface of the blade housing 120 opposing the top surface 121.

On the top surface 121 of the blade housing 120, the guard 122 may be located in front of the shaving blade 110, and the cap 124 may be located in the rear of the shaving blade 110. Herein, the front and rear sides of the shaving blade 110 are defined based on a shaving direction of the razor cartridge 12.

The guard 122 may stretch the skin in the shaving direction before the body hair is cut by the shaving blade 110 during shaving.

Accordingly, the body hair of the user can stand in a direction perpendicular to the skin surface of the user, whereby the shaving blade 110 can more easily cut the body hair.

The connector 130 may be fixed to one side of the blade housing 120. For example, the connector 130 may be mounted on and fixed to the blade housing 120 after being manufactured as a separate member from the blade housing 120 in order to strengthen coupling between the connector 130 and a razor handle (not illustrated). In this case, the connector 130 may be fixed to the bottom surface 123 of the blade housing 120 or one surface between the top surface 121 and the bottom surface 123.

However, the present disclosure is not limited thereto, and the connector 130 may be integrally manufactured with the blade housing 120. For example, the connector 130 may be formed by being injected onto the bottom surface 123 or one side surface of the blade housing 120. In this case, the connector 130 and the blade housing 120 may be integrally formed.

The holder 140 may be connected rotatably about a rotational axis (RA) parallel to the connector 130 in the longitudinal direction. The position of the holder 140 may be fixed with respect to a razor handle (not illustrated).

In the razor assembly 10 according to one embodiment of the present disclosure, even when the position of the connector 130 is fixed with respect to the razor cartridge 12 and the position of the holder 140 is fixed with respect to the razor handle (not illustrated), the connector 130 is configured to be movable relative to the holder 140, and thus, there is a technical feature in implementing a pivot function of the razor cartridge 12.

Therefore, according to the razor assembly 10 according to one embodiment of the present disclosure, it is possible to reduce a size of the cartridge unit including the razor cartridge 12 and the connector 130, and the durability of the razor assembly 10 may be improved. Meanwhile, the holder 140 may be a separate component from the razor handle (not illustrated), but may be integrally formed with the razor handle.

The razor assembly 10 may additionally include a recovering force providing unit 150 and an ejecting unit 160.

The recovering force providing unit 150 may provide a recovering force for restoring the connector 130 pivoted about a rotational axis (RA) to a rest position, and the ejecting unit 160 can separate the connector 130 from the holder 140.

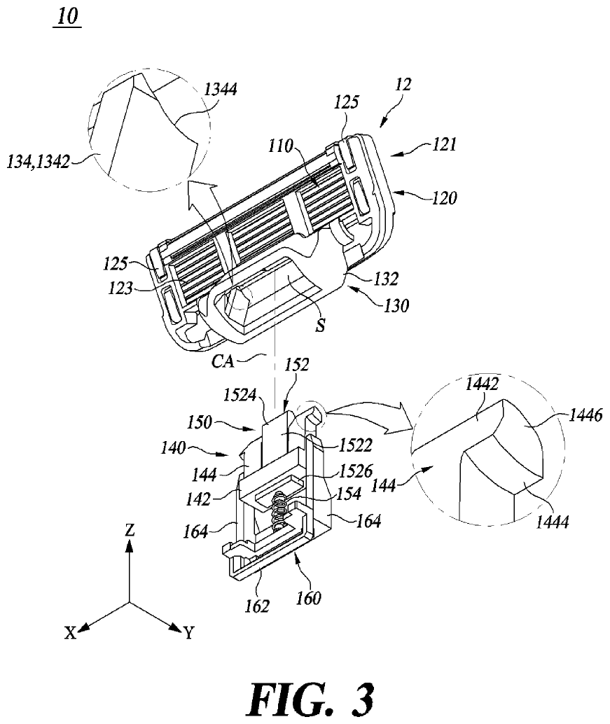

FIG. 3 illustrates a state in which the razor cartridge 12 of FIG. 2 is separated from the holder 140.

Referring to FIG. 3, the connector 130 may include a connector body 132 and a first connecting portion 134, and the holder 140 may include a holder body 142 and a second connecting portion 144.

The connector body 132 may form the outer shape of the connector 130 and may define an accommodation space S for accommodating the holder 140.

The first connecting portion 134 may be formed on one side of the connector body 132. Specifically, the first connecting portion 134 may be formed to face at least a portion of the holder 140 accommodated in the accommodation space S, for example, at least a portion of the second connecting portion 144.

The first connecting portion 134 may include a cantilever 1342 and a first surface 1344.

The cantilever 1342 may be configured to be biased towards the center of the connector 130. Specifically, the cantilever 1342 may be configured to be biased toward a central axis (CA) that is perpendicular to the longitudinal direction and passes through the center of the connector 130.

In addition, the cantilever 1342 may extend from one side of the connector 130, for example, one side of the connector body 132 toward the front in the mounting direction.

The first surface 1344 may be formed on one side of the first connecting portion 134, for example, a free end of the cantilever 1342.

Here, forward in the mounting direction refers to a moving direction of the holder 140 when the holder 140 is mounted in the accommodation space S of the connector 130. In addition, rearward in the mounting direction, which will be described later, refers to a moving direction of the holder 140 when the holder 140 is separated from the accommodation space S of the connector 130. For example, in FIG. 3, forward in the mounting direction is a positive Z-axis direction, and rearward in the mounting direction is a negative Z-axis direction.

The second connecting portion 144 may be formed on one side of the holder body 142. Specifically, the second connecting portion 144 may extend from one side of the holder body 142 forward in the mounting direction.

The second connecting portion 144 may be accommodated in the accommodation space S of the connector 130, and may face at least a portion of the first connecting portion 134 in a state of being accommodated in the accommodation space S.

The second connecting portion 144 may include a protrusion 1442 configured to hook-couple with one end of the cantilever 1342.

The protrusion 1442 may protrude parallel to the longitudinal direction from one end of the second connecting portion 144 spaced apart from the holder body 142.

The connector 130 and the holder 140 may be connected by combining the first connecting portion 134 and the second connecting portion 144. For example, the second connecting portion 144 may be hook-coupled to the first connecting portion 134. In this case, the protrusion 1442 of the second connecting portion 144 may be hook-coupled with one end of the cantilever 1342 of the first connecting portion 134.

However, the present disclosure is not limited thereto, and the second connecting portion 144 may be connected to the first connecting portion 134 through a method such as a snap-fit.

One or more first connecting portions 134 may be provided on the connector 130, and preferably, a pair of first connecting portions 134 may be provided. In this case, the pair of first connecting portions 134 may be disposed to face each other and may have symmetrical shapes.

The second connecting portion 144 may be disposed at a position corresponding to the first connecting portion 134. For example, when the connector 130 is provided with a pair of first connecting portions 134, the holder 140 may also be provided with a pair of second connecting portions 144. In this case, each second connecting portion 144 may be disposed at a position corresponding to each first connecting portion 134.

The protrusion 1442 may include a second surface second surface 1444 and a third surface 1446.

The second surface 1444 may be formed on one side of the protrusion 1442 adjacent to the holder body 142. In addition, the second surface 1444 may face the first surface 1344 of the first connecting portion 134 in a state in which the holder 140 is mounted on the connector 130.

When the connector 130 rotates with respect to the holder 140 around the rotational axis (RA), the first surface 1344 may move with respect to the second surface 1444 along the second surface 1444.

The first surface 1344 may have a concave surface and the second surface 1444 may have a convex surface corresponding to the concave surface of the first surface 1344.

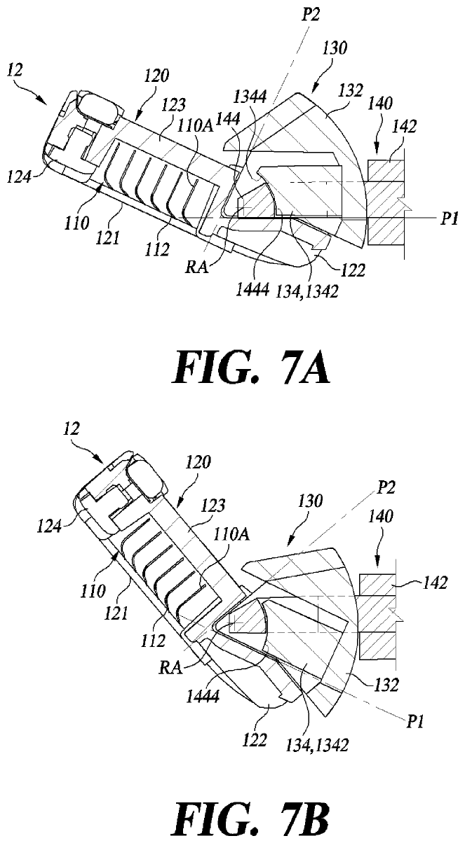

Accordingly, the second surface 1444 can be firmly seated on the first surface 1344, and the connector 130 can pivot more smoothly with respect to the holder 140. Details regarding this are described with respect to FIG. 7.

Referring back to FIG. 3, the third surface 1446 may be formed on the other side of the protrusion 1442 spaced apart from the holder body 142. The third surface 1446 may be configured to press the cantilever 1342 while the holder 140 is connected to the connector 130.

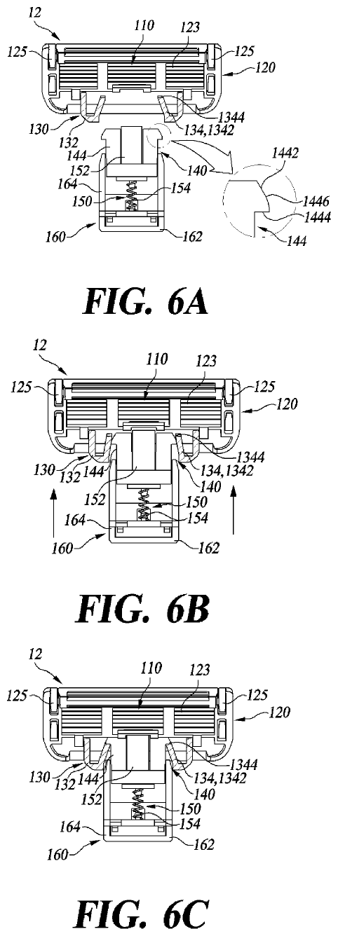

When the cantilever 1342 is pressed by the third surface 1446, the cantilever 1342 may be elastically deformed in a direction away from the center of the connector 130. Details regarding this are described with respect to FIG. 6.

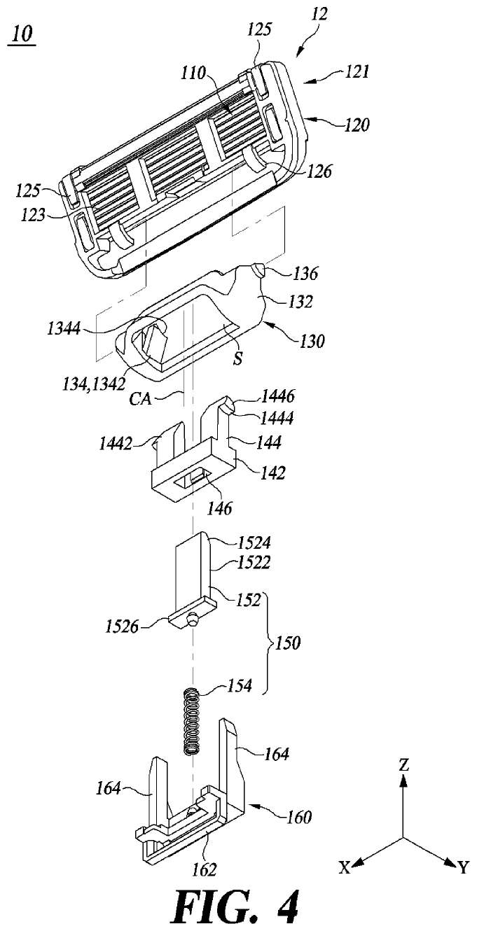

FIG. 4 is an exploded perspective view of the razor assembly 10 according to one embodiment of the present disclosure.

Referring to FIG. 4, the recovering force providing unit 150 may include a plunger 152 and an elastic member 154, and the plunger 152 may include a plunger body 1522 and a cam surface 1524.

At least a portion of the plunger body 1522 may pass through a through hole 146 formed in the holder body 142. The plunger body 1522 may move parallel to the mounting direction in a state of passing through the through hole 146.

The through hole 146 may be formed between the pair of second connecting portions 144. Accordingly, the recovering force providing unit 150, for example, at least a portion of the plunger body 1522, may be disposed between the pair of second connecting portions 144. Therefore, the recovering force providing unit 150 can be arranged space-efficiently, and provide a recovering force through a simpler structure.

The cam surface 1524 may be formed at one end of the plunger body 1522 adjacent to the blade housing 120. The cam surface 1524 may perform a cam action with a portion of the blade housing 120 or a portion of the connector 130, thereby providing a recovering force to the razor cartridge 12.

The elastic member 154 may be configured to provide an elastic force to the plunger 152. The elastic force generated from the elastic member 154 may function as a recovering force for restoring the razor cartridge 12 to a rest position.

One side of the elastic member 154 adjacent to the blade housing 120 may be connected to the plunger 152, for example, the plunger body 1522.

In addition, the other side of the elastic member 154 spaced apart from the blade housing 120 may be connected to the ejecting unit 160, for example, an ejecting unit body 162. However, the present disclosure is not limited thereto, and the other side of the elastic member 154 may be connected to a member other than the ejecting unit 160, for example, to a portion of a razor handle (not illustrated).

The plunger 152 may additionally include a stopper 1526.

The stopper 1526 may protrude from one side of the plunger body 1522 in a direction perpendicular to the extending direction of the plunger body 1522.

In addition, the stopper 1526 may be disposed rearward of the holder body 142 in the mounting direction, and may face one surface of the holder body 142 spaced apart from the blade housing 120.

When the plunger body 1522 moves forward in the mounting direction, the stopper 1526 may contact one surface of the holder body 142. Accordingly, a movement of the plunger body 1522 forward in the mounting direction may be prevented.

The ejecting unit 160 may include the ejecting unit body 162 and an arm 164.

The ejecting unit body 162 may be disposed rearward of the holder 140 in the mounting direction.

The arm 164 may extend from one side of the ejecting unit body 162 forward in the mounting direction.

At least a portion of the holder 140 may be disposed between a pair of arms 164. For example, a portion of the second connecting portion 144 and the holder body 142 may be disposed between the pair of arms 164. Therefore, the ejecting unit 160 can be arranged space-efficiently.

The arm 164 is disposed rearward of the protrusion 1442 in the mounting direction and is movable with respect to the protrusion 1442 along the mounting direction.

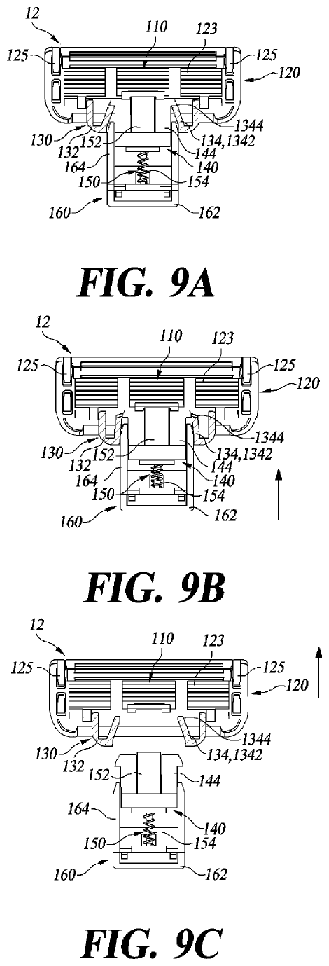

When the arm 164 moves forward in the mounting direction toward the protrusion 1442, the arm 164 may press the cantilever 1342 of the first connecting portion 134 in a direction away from the center of the connector 130. Accordingly, the coupled state between the first connecting portion 134 and the second connecting portion 144 may be terminated, and thus, the connector 130 may be separated from the holder 140. Details regarding this are described with respect to FIG. 9.

Referring back to FIG. 4, the connector 130 may additionally include a third connecting portion 136. In addition, the blade housing 120 may additionally include a fourth connecting portion 126.

One of the third connecting portion 136 and the fourth connecting portion 126 may include a coupling protrusion, and the other of the third connecting portion 136 and the fourth connecting portion 126 may include a coupling hole corresponding to the coupling protrusion. In this case, the coupling protrusion may be inserted into the coupling hole, whereby the connector 130 and the blade housing 120 may be connected.

However, the present disclosure is not limited thereto. For example, the third connecting portion 136 and the fourth connecting portion 126 may be connected through a hook-coupling or a snap-fit.

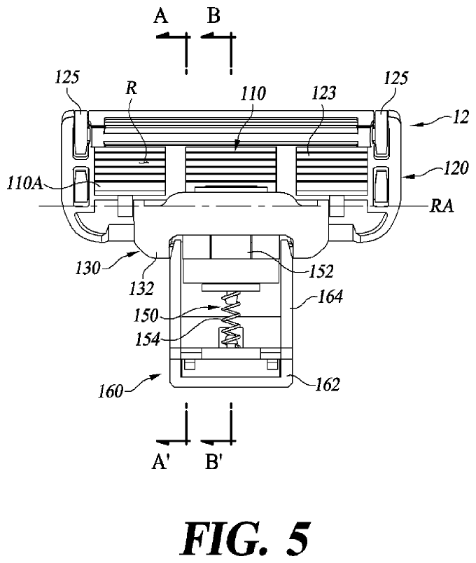

FIG. 5 is a rear view of the razor assembly 10 according to one embodiment of the present disclosure.

The razor assembly 10 according to one embodiment of the present disclosure simultaneously achieves the connection between the connector 130 and the holder 140 and the pivot function of the razor cartridge 12 using the first connecting portion 134 and the second connecting portion 144.

Therefore, in the razor assembly 10 according to one embodiment of the present disclosure, the connection between the connector 130 and the holder 140 and the rotational axis (RA) of the razor cartridge 12 may be implemented at positions adjacent to each other.

Meanwhile, the rotational axis (RA) of the razor cartridge 12 is generally located in front of a frontmost blade 110A of the shaving blades 110. Therefore, the connection between the connector 130 and the holder 140 may also be formed in front of the foremost blade 110A, and the connector 130 may be located relatively close to the front area of the blade housing 120.

For example, referring to FIG. 5, when viewed from the bottom surface 123 of the blade housing 120, the connector 130 may not overlap with at least one shaving blade 110. In this case, a rinsing space R is widened, and thus washing of the shaving blade 110 by the washing water can be performed more effectively.

However, the present disclosure is not limited thereto. For example, the connector 130 may be disposed on the blade housing 120 such that at least a portion of the connector 130 overlaps with at least one shaving blade 110.

In this case, the coupling between the connector 130 and the blade housing 120 can be formed over a wider area, and the connector 130 can be more firmly fixed to the blade housing 120.

FIG. 6 illustrates a process of assembling the razor cartridge 12 to the second connecting portion 144 according to one embodiment of the present disclosure.

In FIG. 6, for convenience of explanation, a part of the upper region of the connector body 132 is omitted.

Referring to FIG. 6A and FIG. 6B, while the second connecting portion 144 of the holder 140 is inserted into the accommodation space S of the connector 130, a cam action may occur between the third surface 1446 of the protrusion 1442 and the cantilever 1342 of the first connecting portion 134.

The third surface 1446 may press the cantilever 1342 in a direction away from the center of the connector 130 through this cam action, and the cantilever 1342 pressed by the third surface 1446 may be elastically deformed in a direction away from the center of the connector 130.

Meanwhile, for a smooth cam action, in the state before the holder 140 is coupled to the connector 130, the largest interval in the longitudinal direction of the pair of second connecting portions 144 may be larger than the smallest interval in the longitudinal direction of the first connecting portion 134.

For example, in the state before the holder 140 is coupled to the connector 130, the interval in the longitudinal direction between the free ends of the pair of protrusions 1442 may be larger than the interval in the longitudinal direction between the free ends of the pair of cantilevers 1342.

Referring to FIG. 6B and FIG. 6C, when the second connecting portion 144 is completely inserted into the accommodation space S, the cam action state between the third surface 1446 and the cantilever 1342 may be terminated.

Through termination of the cam action state, the third surface 1446 no longer presses the cantilever 1342, and accordingly, the cantilever 1342 may be biased toward the center of the connector (130) again by the elastic force.

When the cantilever 1342 is biased toward the center of the connector 130 again, the first surface 1344 of the first connecting portion 134 and the second surface 1444 of the second connecting portion 144 may face each other, and accordingly, the first connecting portion 134 and the second connecting portion 144 may be coupled to each other.

In this case, since the second surface 1444 has a shape corresponding to that of the first surface 1344, the first connecting portion 134 and the second connecting portion 144 can be more firmly coupled.

Meanwhile, in the razor assembly 10 according to one embodiment of the present disclosure, through a simple operation of inserting the second connecting portion 144 of the holder 140 into the accommodation space S of the connector 130, the coupling between the first connecting portion 134 and the second connecting portion 144 can be easily implemented. Thus, the user can easily mount the razor cartridge 12 on the razor handle (not illustrated).

FIG. 7 illustrates a state in which the razor cartridge 12 according to one embodiment of the present disclosure is rotating. Specifically, FIG. 7 illustrates a cross-sectional view of the razor assembly 10 cut in a direction A-A′ of FIG. 6.

Moreover, FIG. 7A illustrates a state in which the razor cartridge 12 is in the rest position, and FIG. 7B illustrates a state in which the razor cartridge 12 is rotated from the rest position.

Referring to FIG. 7A and FIG. 7B, the first surface 1344 may have a concave surface, and the second surface 1444 may have a convex surface corresponding to the concave surface of the first surface 1344. For smooth pivoting of the razor cartridge 12, the surface of the first surface 1344 and the surface of the second surface 1444 may have a profile of an arc centered on the rotational axis (RA).

Moreover, the second surface 1444 may be closer to the rotational axis (RA) than the first surface 1344.

In addition, the rotational axis (RA) may pass through at least a portion of the second connecting portion 144, for example, a front area of the second connecting portion 144. Therefore, the rotational axis (RA) may be closer to the frontmost blade 110A among the shaving blades 110, and thus, the razor assembly 10 can implement a more improved pivot function.

However, the present disclosure is not limited thereto, and the rotational axis (RA) may pass through the center of the second connecting portion 144 or the rear area of the second connecting portion 144, or may not pass through the second connecting portion 144.

When the rotational axis (RA) does not pass through the second connecting portion 144, the rotational axis (RA) may be located adjacent to the second connecting portion 144, and may pass through the area of the blade housing 120 adjacent to the second connecting portion 144.

While the connector 130 rotates with respect to the holder 140 around the rotational axis (RA), the first surface 1344 may move with respect to the second surface 1444 along the second surface 1444.

The first surface 1344 may have a relatively larger area than the second surface 1444 so that a contact area between the first surface 1344 and the second surface 1444 can be maintained larger than a certain size while the connector 130 rotates. Accordingly, regardless of the degree of rotation of the connector 130, the first connecting portion 134 and the second connecting portion 144 may be firmly coupled.

At least one of the blade housing 120 and the connector 130 may define a first stop surface P1 and a second stop surface P2 that limit the range of rotation of the connector 130. The second connecting portion 144, for example, the protrusion 1442, may be supported by any one of the first stop surface P1 and the second stop surface P2, whereby the range of rotation of the connector 130 may be limited.

For example, referring to FIG. 7A, the protrusion 1442 is supported by the first stop surface P1, and thus, the rotation of the connector 130 in the counterclockwise direction with reference to FIG. 7 may be limited. Moreover, referring to FIG. 7B, the protrusion 1442 is supported by the second stop surface P2, and thus, the rotation of the connector 130 in the clockwise direction with reference to FIG. 7 may be limited.

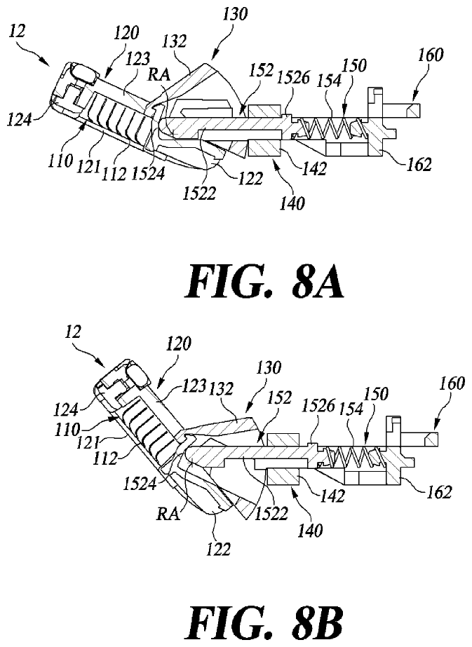

Meanwhile, since the connector 130 is fixed to the razor cartridge 12 and the holder 140 is fixed to the razor handle (not illustrated), when the connector 130 rotates with respect to the holder 140, the razor cartridge 12 may pivot with respect to the razor handle (not illustrated). FIG. 8 illustrates an operation of the recovering force providing unit when the razor cartridge 12 according to one embodiment of the present disclosure rotates. Specifically, FIG. 8 illustrates a cross-sectional view of the razor assembly 10 cut in a direction B-B′ of FIG. 6.

Moreover, FIG. 8A illustrates a state in which the razor cartridge 12 is in the rest position, and FIG. 8B illustrates a state in which the razor cartridge 12 is rotated from the rest position.

Referring to FIG. 8A and FIG. 8B, when the razor cartridge 12 rotates from the rest position, the cam surface 1524 may perform a cam action with a portion of the blade housing 120 or a portion of the connector 130.

Through this cam action, the plunger 152 may be pressed rearward in the mounting direction, or may provide a recovering force to the razor cartridge 12. A process in which the recovering force providing unit 150 provides a recovering force to the razor cartridge 12 will be described in detail.

One side of the elastic member 154 adjacent to the blade housing 120 may be connected to the plunger body 1522, and the other side of the elastic member 154 spaced apart from the blade housing 120 may be connected to a portion of the ejecting unit body 162 or the razor handle (not illustrated).

Meanwhile, the position of the other side of the elastic member 154 may be fixed. Therefore, when the plunger 152 moves rearward in the mounting direction by the cam action, the elastic member 154 may be compressed.

When the elastic member 154 is compressed, an elastic force may be generated inside the elastic member 154, and the elastic force of the elastic member 154 may be transmitted to the razor cartridge 12 through the cam surface 1524 of the plunger 152.

The elastic force transmitted to the razor cartridge 12 may act as a force to restore the rotated razor cartridge 12 to the rest position. That is, the elastic force generated from the elastic member 154 may function as a recovering force for restoring the razor cartridge 12.

FIG. 9 illustrates a process in which the razor cartridge 12 is separated from the second connecting portion 144 according to one embodiment of the present disclosure.

Referring to FIG. 9A and FIG. 9B, in a state in which the connector 130 is connected to the holder 140, the user may move the arm 164 forward in the mounting direction toward the protrusion 1442. For example, the user may move the arm 164 forward in the mounting direction by pushing a button (not illustrated) connected to the ejecting unit 160 forward in the mounting direction.

In this case, since the position of the plunger 152 is fixed, the position of one side of the elastic member 154 connected to the plunger 152 may also be fixed. Therefore, when the other side of the elastic member 154 moves forward in the mounting direction together with the ejecting unit body 162, the elastic member 154 disposed between the plunger 152 and the ejecting unit body 162 may be compressed.

Meanwhile, the arm 164 may be located rearward of the protrusion 1442 in the mounting direction. Accordingly, the arm 164 may elastically deform the cantilever 1342 in a direction away from the center of the connector 130 while moving forward in the mounting direction.

In this case, since the cantilever 1342 is elastically deformed in a direction away from the center of the connector 130, the coupled state between the first connecting portion 134 and the second connecting portion 144 may be terminated.

Referring to FIG. 9B, immediately after the coupling between the first connecting portion 134 and the second connecting portion 144 is released, the cantilever 1342 may be pressed by the arm 164. In this case, the cantilever 1342 may be sufficiently opened up in a direction away from the center of the connector 130.

A space between the pair of opened up cantilevers 1342 may be sufficient for the pair of second connecting portions 144 to eject from the connector 130. Accordingly, the user may separate the razor cartridge 12 from the second connecting portion 144 in a state where the cantilever 1342 is sufficiently opened up by the arm 164.

Referring to FIG. 9C, when the razor cartridge 12 is separated from the second connecting portion 144, the elastically deformed cantilever 1342 may be biased toward the center of the connector 130 again by the elastic force.

Meanwhile, the ejecting unit body 162 may be connected to the other side of the elastic member 154. Therefore, when the razor cartridge 12 is separated from the second connecting portion 144, the ejecting unit 160 may return rearward in the mounting direction again by the elastic member 154.

In the razor assembly 10 according to one embodiment of the present disclosure, the recovery force providing unit 150 generating the recovering force and restoring of the ejecting unit 160 to the initial position may be implemented through a single component such as the elastic member 154. That is, the recovering force providing unit 150 and the ejecting unit 160 may share and utilize the elastic member 154, whereby the configurations of the recovering force providing unit 150 and the ejecting unit 160 may be further simplified.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

### CROSS-REFERENCE TO RELATED APPLICATION

This application claims priority to Patent Application No. 10-2020-0109886, filed on Aug. 31, 2020 in Korea, the entire contents of which are incorporated herein by reference.

### EXPLANATION OF CODE

10: razor assembly, 12: razor cartridge, 110: shaving blade, 112: cutting edge, 120: blade housing, 130: connector, 132: connector body, 134: first coupling part, 140: holder, 142: holder body; 144: second coupling part, 150: restoring force providing part, 152: plunger, 154: elastic member, 160: breakout part, 162: breakaway body, 164: arm, 1342: cantilever beam, 1344: first surface, 1442: protrusion, 1444: second surface, 1446: third surface, RA: axis of rotation

1. A razor assembly comprising:
at least one shaving blade having a cutting edge;
a blade housing accommodating the at least one shaving blade to be placed in a longitudinal direction;
a connector fixed to one side of the blade housing, the connector including a first connecting portion including a first surface; and
a holder rotatably connected to the connector about a rotational axis parallel to the longitudinal direction, the holder including a second connecting portion including a second surface facing the first surface,
wherein the connector and the holder are connected to each other by coupling of the first connecting portion and the second connecting portion, and
wherein when the connector rotates with respect to the holder about the rotational axis, the first surface is configured to move with respect to the second surface along the second surface.

2. The razor assembly of claim 1, wherein the second surface is closer to the rotational axis than the first surface.

3. The razor assembly of claim 1, wherein the rotational axis passes through at least a portion of the second connecting portion.

4. The razor assembly of claim 1, wherein the first surface has a concave surface, and
the second surface has a convex surface corresponding to the concave surface of the first surface.

5. The razor assembly of claim 4, wherein a surface of the first surface and a surface of the second surface have a profile of an arc centered on the rotational axis.

6. The razor assembly of claim 1, wherein the first connecting portion includes a cantilever configured to be biased toward a center of the connector and extending from one side of the connector toward in a mounting direction, and
wherein the second connecting portion includes a protrusion configured to hook-couple with one end of the cantilever, wherein
the cantilever includes a first surface formed on one end of the cantilever, and
the protrusion includes a second surface formed on one side of the protrusion.

7. The razor assembly of claim 6, wherein the protrusion further includes a third surface configured to press the cantilever while the holder is connected to the connector, wherein
the cantilever is configured to be elastically deformed in a direction away from the center of the connector by being pressed by the third surface.

8. The razor assembly of claim 7, further comprising an ejecting unit configured to separate the connector from the holder,
wherein the ejecting unit includes an arm disposed behind the protrusion in the mounting direction and movable with respect to the protrusion along the mounting direction, and
in a state where the connector is connected to the holder, the arm moves forward in the mounting direction toward the protrusion to elastically deform the cantilever in the direction away from the center of the connector.

9. The razor assembly of claim 1, further comprising a recovering force providing unit configured to provide a recovering force for restoring the connector rotated about the rotational axis to a rest position,
wherein the holder includes a pair of second connecting portions, and
wherein at least a portion of the recovering force providing unit is disposed between the pair of second connecting portions.

10. The razor assembly of claim 9, further comprising an ejecting unit configured to separate the connector from the holder,
wherein the recovering force providing unit includes a plunger, at least a part of which is disposed between the pair of second connecting portions and configured to transmit the restoring force by performing a cam action with at least one of the blade housing and the connector, and an elastic member configured to provide an elastic force to the plunger, and
wherein one side of the elastic member adjacent to the blade housing is connected to the plunger, and the other side of the elastic member spaced apart from the blade housing is connected to the ejecting unit.

11. The razor assembly of claim 1, wherein the second connecting portion is hook-coupled to the first connecting portion.

12. The razor assembly of claim 1, wherein the blade housing includes a top surface toward which the cutting edge faces and a bottom surface opposing the top surface, and
wherein when viewed from the bottom surface, the connector does not overlap with the at least one shaving blade.
